(19) United States
(12) Patent Application Publication
(10) Pub. No.: US 2008/0126138 A1
(43) Pub. Date: May 29, 2008

(54) System and method for presenting insurance offers

(75) Inventors: Jerry A. Cherney, Glenview, IL (US); Sridhar Pallapotu, Chicago, IL (US)

Correspondence Address: Jerry A. Cherney, 3280 N. California Avenue, Chicago, IL, 60618, US

(73) Assignee: Eagle Insurance Agency, Inc., Chicago, IL (US)

(21) Appl. No.: 11/603,999

(22) Filed: Nov. 24, 2006

(51) Int. Cl. G06Q 40/00

(52) U.S. Cl. 705/4

(57) ABSTRACT

A system and method for presenting insurance offers is provided. User information is received via a user interface. A database stores the user information, and also stores a plurality of insurance policy offers, each of which has a corresponding base purchase value. An offer interface is provided for presenting a selected insurance policy offer from among the plurality of insurance policy offers stored in the database, wherein the selected insurance policy is selected based on the user information. The selected insurance policy further has a corresponding adjusted purchase value, which is based on the base purchase value and is increased or decreased based on the user information.

### TECHNICAL FIELD

The invention relates to a system and method for presenting insurance offers. More particularly, the present invention provides a system and method for querying a database to provide a selected insurance offer based on user information received from a user.

### BACKGROUND OF THE INVENTION

A variety of techniques are known for presenting insurance policy offers to people seeking life and property insurance. Such known methods include advertisements, for example, which run on television and encourage people to contact the insurance company via telephone or personal appointment. Then, over the telephone or in person, an insurance agent will assess a variety of factors in determining a quote, or price at which the insurance company offers to insure the life or property of the person.

More recently, insurance companies have employed the Internet to present insurance quotes to Internet users. In their earliest form, insurance websites were restricted to advertisement alone, wherein the website simply comprised contact information encouraging the user to contact the insurance company at a telephone number or physical office location. In a more recent embodiment, insurance websites have begun using interactive forms via the Internet. Typically, a user visits an insurance website and provides certain requested information. For example, if the user wishes to insure her car, the user will be requested to provide information identifying the car and driving habits of the user. The user will also be requested to provide her driver's license number and social security number, or other personal identifying information.

Based on that information, the insurance website provides a quote for an insurance policy to the user. In preparing the quote, a variety of known methods are used. For example, if the user's car is more than a predetermined number of years old, the insurance premium decreases by a predetermined amount. As another example, if the user has a predetermined number of “points” on her driver's license, the insurance premium then increases by a predetermined amount. Insurance premiums and quotes are also determined based on the financial history of the user. For example, if the user has a good credit history, the insurance premium is typically decreased. If by contrast the user has a poor credit history, the insurance premium is typically increased. Thus, the insurance premium and quote is based on the property to be insured (e.g., the make, model and age of a vehicle), but is also based on the driving and financial history of the user.

To retrieve such information, insurance websites must consult fee-based databases that store that information. A variety of known services exist to accomplish that purpose; all such services require an access charge. Thus, to prepare an insurance policy quote for a user, based on the user's driving record and financial history, the system must access a fee-based database storing driving record information and financial history for the user. The process of preparing the quote, which is typically of no cost to the user, is therefore nonetheless of cost to the owner of the system.

Moreover, known systems for providing insurance offers typically suffer from being overly complicated and difficult for users to use and navigate. Such systems frequently have dozens of “pages”, or portions at which the user is asked questions about herself and her property. The user is thus required to navigate through those dozens of pages, a process which can be both time-consuming and aggravating to the user. One serious concern for systems providing insurance quote information is the rate of user attrition, which increases dramatically based on the length of the user-inquiry portion of the system. In other words, users are simply turned away by larger systems that ask a large number of complex personal questions. In addition, the inquiries made of the user by such systems are sometimes complicated and difficult to understand, particularly for older or younger users. Therefore, while some of the known systems are within the range of competence and tolerance of an average user, they are nonetheless inoperable by users who are unfamiliar with either computer technology or the insurance process as a result of their age or other personal characteristic, such as a handicap or mental illness.

A need has thus arisen for a system and method for providing insurance offers that is inexpensively operated on behalf of the owner of the system. A need has further arisen for a system and method that can be executed more quickly than previous known systems of this type. A need has further arisen for a system and method that is easier to operate than previous known systems of this type.

The present invention is provided to solve the problems discussed above and other problems, and to provide advantages and aspects not provided by prior systems and methods of this type. A full discussion of the features and advantages of the present invention is deferred to the following detailed description, which proceeds with reference to the accompanying drawings.

### SUMMARY OF THE INVENTION

A system for presenting insurance offers is provided, comprising a user interface for receiving user information. The system further comprises a database for storing the user information and a plurality of insurance policy offers. The system also comprises an offer interface for presenting a selected insurance policy from among the plurality of insurance policy offers. The selected insurance policy offer is based on the user information.

In one embodiment, the user information comprises user name, user residency, vehicle model, vehicle make, user age, insured vehicle quantity, prior insurance duration, user gender, user marital status, user driving license stats, vehicle identification number, vehicle purpose data and/or preferred coverage type. In another embodiment, the user information comprises information corresponding to a plurality of users. In yet another embodiment, the user information comprises information corresponding to a plurality of vehicles. In a further embodiment, the database correlates each of the plurality of insurance policy offers with a base purchase value.

In one embodiment, the system further comprises a processor for generating an adjusted purchase value for at least one of the plurality of insurance policy offers, wherein the adjusted purchase value is based on the base purchase value. In another embodiment, the adjusted purchase value is based on user residency, vehicle model, vehicle make, user age, insured vehicle quantity, prior insurance duration, user gender, user marital status, user driving license status, vehicle purpose data and/or preferred coverage type. In yet another embodiment, the user interface comprises a visual component representative of a human form, and an audio component representative of a human voice. In a further embodiment, the user information does not comprise either user driving record information or user financial history information. In another embodiment, the offer interface comprises a plurality of purchase options for purchasing the selected insurance policy offer.

The present invention further provides a method for presenting insurance offers, comprising the step of receiving user information via a user interface. The method further comprises the step of querying a database storing a plurality of insurance policy offers, wherein the query comprises the user information. The method also includes the step of selecting from among the plurality of insurance policy offers a selected insurance policy offer, wherein the selected insurance policy offer has a purchase value, and wherein the purchase value is generated based on the user information. The method also includes the step of generating an offer interface comprising the selected insurance policy offer.

The present invention further provides a user interface for presenting insurance offers. The user interface comprises a first portion for receiving user information comprising demographic information identifying the user as belonging to a demographic category. The interface further comprises a second portion for receiving vehicle information identifying a vehicle. The interface lastly comprises a third portion for presenting a selected insurance policy to the user, wherein the selected insurance policy has a purchase value that is determined based on the demographic category, and wherein the purchase value is not based on a user driving record or a user financial history.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is an illustration of a personal computing device for use with the present invention;

FIG. 2 is an illustration of a computer network and Internet connection for use with the present invention;

FIG. 3 is an illustration of a first user interface visual field for use in providing user information to the system;

FIG. 4 is an illustration of a second user interface visual field for use in providing user information to the system;

FIG. 5 is an illustration of a third user interface visual field for use in providing user information to the system;

FIG. 6 is an illustration of a fourth user interface visual field for use in providing user information to the system;

FIG. 7 is an illustration of a fifth user interface visual field for use in providing user information to the system;

FIG. 8 is an illustration of a sixth user interface visual field for use in providing user information to the system;

FIG. 9 is an illustration of a user interface for providing instruction and information to a user of the present invention; and,

FIG. 10 is an illustration of an offer interface for presenting the user with an insurance policy offer.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The process descriptions or blocks shown in the figures of the various embodiments discussed should be understood as representing modules, segments, or portions of code which include one or more executable instructions for implementing specific logical functions or steps in the process. Alternate implementations are included within the scope of the various embodiments in which functions may be executed out of order from that shown or discussed, including substantially concurrently or in reverse order, depending on the functionality involved, as would be understood by those having ordinary skill in the art.

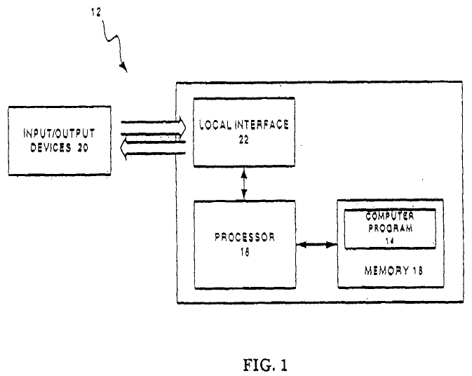

Referring initially to FIG. 1, a block diagram of a computer or server 12 is provided. For purposes of understanding the hardware as described herein, the terms “computer” and “server” have identical meanings and are interchangeably used. The computer 12 includes an insurance policy offer system 14. The insurance policy offer system 14 of the invention can be implemented in software (e.g., firmware), hardware, or a combination thereof. In the currently contemplated best mode, the insurance policy offer system 14 is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. An example of a general purpose computer that can implement the insurance policy offer system 14 of the present invention is shown in FIG. 1. The insurance policy offer 14 may reside in, or have portions residing in, any computer such as, but not limited to, a general purpose personal computer. Therefore, the computer 12 of FIG. 1 may be representative of any computer in which the cash flow analysis system 14 resides or partially resides.

Generally, in terms of hardware architecture, as shown in FIG. 1, the computer 12 includes a processor 16, memory 18, and one or more enter and/or output (I/O) devices 20 (or peripherals) that are communicatively coupled via a local interface 22. The local interface 22 can be, for example, but not limited to, one or more buses or other wired or wireless connections, as is known in the art. The local interface 22 may have additional elements, which are omitted for simplicity, such as controllers, buffers (caches), drivers, repeaters, and receivers, to enable communications. Further, the local interface may include address, control, and/or data connections to enable appropriate communications among the other computer components.

The processor 16 is a hardware device for executing software, particularly software stored in memory 18. The processor 16 can be any custom made or commercially available processor, a central processing unit (CPU), an auxiliary processor among several processors associated with the computer 12, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×8 or Pentium series microprocessor from Intel Corporation, a PowerPC microprocessor from IBM, a Sparc microprocessor from Sun Microsystems, Inc., or a 8xxx series microprocessor from Motorola Corporation.

The memory 18 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 18 may incorporate electronic, magnetic, optical, and/or other types of storage media. The memory 18 can have a distributed architecture where various components are situated remote from one another, but can be accessed by the processor 16.

The software in memory 18 may include one or more separate programs, each of which comprises an ordered listing of executable instructions for implementing logical functions. In the example of FIG. 1, the software in the memory 18 includes the insurance policy offer system 14 in accordance with the present invention and a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). The operating system essentially controls the execution of other computer programs, such as the cash flow analysis system 14, and provides scheduling, enter-output control, file and data management, memory management, and communication control and related services.

The insurance policy offer system 14 may be a source program, executable program (object code), script, or any other entity comprising a set of instructions to be performed. When a source program, the program needs to be translated via a compiler, assembler, interpreter, or the like, which may or may not be included within the memory 18, so as to operate properly in connection with the O/S. Furthermore, the cash flow analysis system 14 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada. In one embodiment, the cash flow analysis system 14 is written in C++. The I/O devices 20 may include enter devices, for example but not limited to, a keyboard, mouse, scanner, microphone, touch screens, interfaces for various medical devices, bar code readers, stylus, laser readers, radio-frequency device readers, etc. Furthermore, the I/O devices 20 may also include output devices, for example but not limited to, a printer, bar code printers, displays, etc. Finally, the I/O devices 20 may further include devices that communicate both enters and outputs, for instance but not limited to, a modulator/demodulator (modem; for accessing another device, system, or network), a radio frequency (RF) or other transceiver, a telephonic interface, a bridge, a router, etc.

If the computer 12 is a PC, workstation, PDA, or the like, the software in the memory 18 may further include a basic enter output system (BIOS) (not shown in FIG. 1). The BIOS is a set of software routines that initialize and test hardware at startup, start the O/S, and support the transfer of data among the hardware devices. The BIOS is stored in ROM so that the BIOS can be executed when the computer 12 is activated.

When the computer 12 is in operation, the processor 16 is configured to execute software stored within the memory 18, to communicate data to and from the memory 18, and to generally control operations of the computer 12 pursuant to the software. The insurance policy offer system 14 and the O/S, in whole or in part, but typically the latter, are read by the processor 16, perhaps buffered within the processor 16, and then executed.

When the insurance policy offer system 14 is implemented in software, as is shown in FIG. 1, it should be noted that the insurance policy offer system 14 can be stored on any computer readable medium for use by or in connection with any computer related system or method. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). The cash flow analysis system 14 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In another embodiment, where the insurance policy offer system 14 is implemented in hardware, the insurance policy offer system 14 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

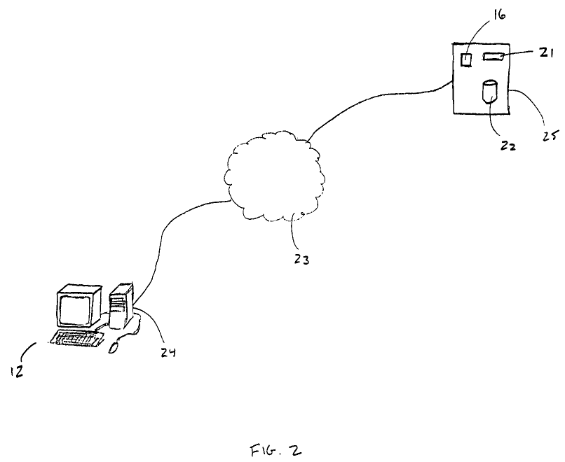

Referring now to FIG. 2, a computer network interface and Internet interface is illustrated. Computer 12 can be placed in communication with other computers via a local computer network or a public computer network such as the Internet. Computer 12 is provided with a network interface 24, which is a combination of hardware and software that enables computer 12 to exchange data with other computers. Network interface 24 is also referred to as a “network card”, communicating with computer 12 via communication protocols such as PCI, SCSI and/or PCMCIA. Network interface 24 communicates with external connection systems such as ethernet, coaxial cable, wireless radio frequency and Bluetooth. Computer 12 can be connected to another computer 12 via the network interface 24, or can be placed in connection with a computer network such as the Internet 23.

Via network interface 24, computer 12 is placed in communication with a “hub” or “router”, in some embodiments via a modem such as a cable modem or a DSL modem. The hub routes communication signals to and from the computer 12. Other computers 12 are also in communication with the hub or router, and communicate with the computer 12 via the hub or router. An interconnection of computer networks, the Internet 23 enables computer 12 on a first computer network to communicate with another computer 12 on a second computer network. Thus, computer 12 is able to communicate via the Internet 23 with web server 25, which is specialized form of a general purpose computer 12.

Web server 25 comprises a processor 16, which is in communication locally with a disk 21, which stores website files. The website files are transferred to the hard drive of the computer 12 via the processor 16 of the server 25 and the Internet 23. The server 25 and computer 12 both have network addresses, which can be TCP/IP, IPX/SPX, Novell, Token Ring or another type of network address. When accessing website files on the server 25, the computer 12 transmits a request for those files to the unique network address for the server 25. In return, the server 25 transmits the requested files to the computer 12 by specifying the unique address of the computer 25. Routers, switches and other hardware comprising the Internet 23 appropriately route the request for files, and the files themselves to the intended addressee, as will be understood by one of skill in the art.

The request for files from computer 12 is accomplished using a known protocol, HTTP. The HTTP request is a specific type of request for website files, such as .html, .htm, .xml, .asp and .cfm files. The files are encoded in a coding language viewable through a web browser, such as Mozilla, Opera or Internet Explorer. The browser decodes the files transmitted from the server 25, and displays them at the computer 12. Each website file can link to additional files, such as image files and sound files. Additionally, the browser, which resides on the hard drive of the computer 12 and is operated through the computer's operating system, can run scripts, which are programs encoded in the website files. The scripts can be in a variety of languages, as will be understood by one of skill in the art, including Java, JavaScript, Flash, Cold Fusion, ASP, XML and SOAP. In one embodiment, the files are composed at the server 25 by reference to a database 22, which stores data and is used to dynamically generate the website files. A variety of known techniques exist for structuring the database 22 and dynamically generating website files based on the data stored in the database 22, including programming languages such as SQL, Cold Fusion, MySQL and ASP.

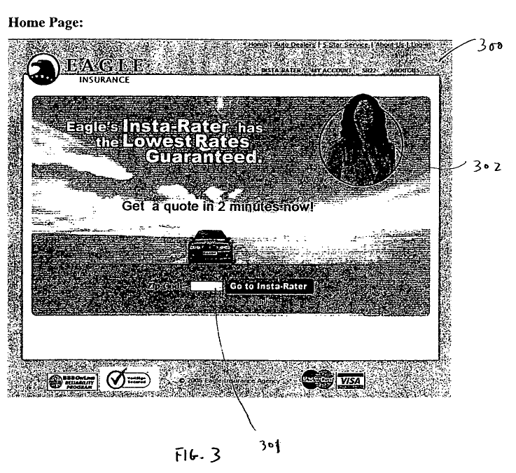

Referring now to FIG. 3, a first user interface 300 is illustrated for use with the system and method for presenting insurance offers. The user interfaces described herein are preferably presented through website files from the server 25 and viewed on the computer 12, in the manner described herein. The user interface 300 comprises a visual field 301 for providing information pertaining to the user's residency, such as the user's zip code. The user interface 300 also comprises a visual component 302 representative of a human form, such as an image of a person. The interface also comprises an audio component (not shown) representative of a human voice. The audio component, played through the computer speakers of the computer 12, instructs the user as to how to provide the requested information to the user interface 300. The audio component can also provide other salient information, such as the estimated length of time remaining before the user's use of the present system will be complete. It will be understood that certain of the requested information in the user interfaces provided herein are mandatory and must be provided by the user in order for the user to be presented with an insurance offer. Other of the requested information are not mandatory.

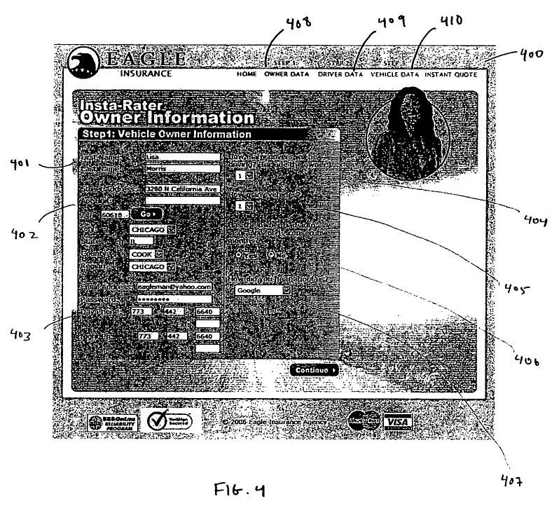

Referring now to FIG. 4, a second user interface 400 is provided for use in collecting user information. The interface 400 comprises visual fields 401 for receiving information pertaining to user identification, such as the user's first and last name. The interface 400 further comprises visual fields 402 for receiving information pertaining to the user's residency, such as the user's address, city, state, county and zip code. The interface 400 also comprises visual fields 403 for receiving information pertaining to the user's contact information, such as the user's email address and telephone number.

The interface 400 further comprises a visual field 404 for receiving information regarding the number of drivers who will drive a vehicle the user wishes to insure. The interface 400 also comprises a visual field 405 for receiving information regarding the number of vehicles the user wishes to insure. A visual field 406 is also provided for receiving information regarding the duration for which the user has owned an insurance policy for the vehicle she wishes to insure. The interface 400 also comprises a visual field 407 for receiving information regarding the user's affiliation with the present website embodiment, i.e., how the user came to be using the present invention.

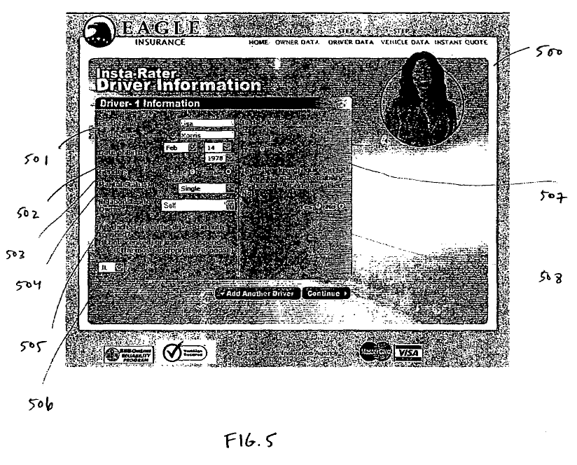

Referring now to FIG. 5, a third user interface 500 is provided for receiving user information. A visual field 501 is provided for receiving user identification information, such as the user's first and last name. In a preferred embodiment, certain of the visual fields, such as visual field 501, are automatically populated for the user based on previously provided information, so as to reduce the amount of time required for the user to complete her use of the present invention. For example, if the user provided user identification information in visual field 401 of the first user interface 400, that information is used to automatically populate visual field 501 of the second user interface 500, so that the user need not re-provide that information. The interface 500 further comprises a visual field 502 for receiving information regarding the user's age, such as the user's date of birth.

Visual field 503 is provided for receiving information regarding the user's gender, and visual field 504 is provided for receiving information regarding the user's marital status. The interface 500 further comprises visual field 505 for receiving information regarding the relationship of the user to the owner of the vehicle to be insured. In a preferred embodiment, the present invention automatically populates that field with “self”, indicating an assumption by the present invention that the user of the website is most likely the owner of the vehicle. The interface 500 also comprises a visual field 506 for receiving information regarding the state of licensure of the user, or party who will drive the insured vehicle. Visual field 507 is provided for receiving information regarding the present status of the driver's license of the driver of the vehicle, such as whether the driver's license is current, suspended, revoked or expired. The interface 500 also comprises a visual field 508 for receiving information regarding whether the user requires additional documentation, such as an industry-known SR-22 statement, indicating that the user or party who will insure the vehicle is not the owner of the vehicle.

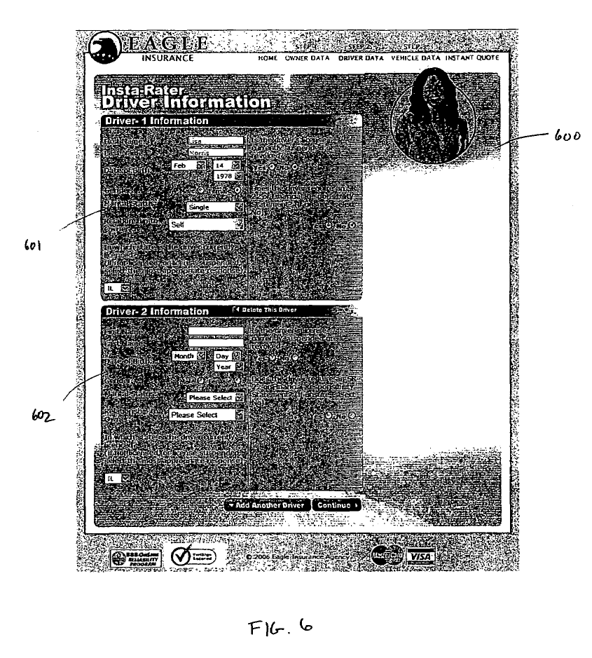

Referring now to FIG. 6, a third user interface 600 is provided for receiving additional user information. The interface 600 comprises first content well 601 and second content well 602, each of which comprises visual fields similar to those provided in the second user interface 500. Interface 600 is provided to the user to provide information regarding additional drivers of the vehicle to be insured. In other words, information regarding the first driver is provided in interface 500, whereas information regarding additional drivers is provided in the optional second interface 600. In a preferred embodiment, interface 600 is generated and provided to the user only upon the user's selection, in interface 400, in visual field 404, that more than one driver will be driving the vehicle to be insured.

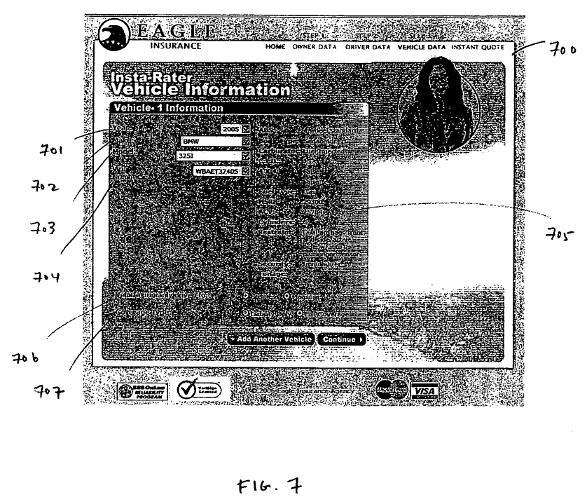

Referring now to FIG. 7, a fourth user interface 700 is provided for receiving additional user information. The interface 700 comprises a visual field 701 for receiving the age of the vehicle to be insured, such as the year in which the vehicle was manufactured. The interface 700 also comprises a visual field 702 for receiving the make of the vehicle, i.e., the manufacturer of the vehicle, such as Chevrolet. The interface 700 further comprises a visual field 702 for receiving the model of the vehicle, such as Trailblazer. The interface 700 also comprises a visual field 704 for receiving information specifically identifying the vehicle, such as the industry-known vehicle identification number. In a preferred embodiment, the visual fields are populated using “pull-down menus”, which are known to one of skill in the art. The pull-down menus are dynamically generated based on previously-provided user information, in a preferred embodiment, thereby reducing the amount of time required for the user to complete her use of the present invention. For example, if the user provides, in visual field 702, that the make of the vehicle is Chevrolet, then the pull-down menu for visual field 703 is dynamically populated with only the models of vehicles manufactured by Chevrolet.

Based on the user information provided in interface 700, the system preferably automatically generates a content well 705 displaying information specific to the vehicle, thereby reducing the amount of time necessary for the user to complete her use of the present invention, by eliminating the need of the user to provide that information. For example, if the user indicates in visual fields 701, 702, 703 that the vehicle to be insured is a 2002 Chevrolet Trailblazer, content well 705 is then, in a preferred embodiment, dynamically populated with information specific to that particular make and model. Anti-lock brakes, four-wheel drive, an anti-theft system and two air bags came standard on the 2002 Chevrolet Trailblazer, and thus all of that information regarding the specific vehicle to be insured is dynamically populated in content well 705 based on the user-provided information. The interface 700 also includes a visual field 706 for receiving information regarding the primary purpose of the use of the vehicle, such as business or pleasure. The interface 700 further comprises a visual field 707 for receiving information regarding the type of insurance coverage sought by the user, such as liability only or comprehensive.

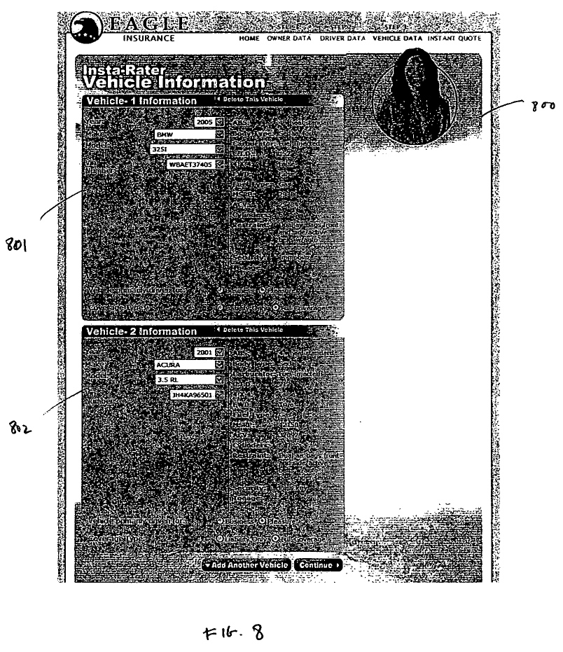

Referring now to FIG. 8, a fifth user interface 800 is provided for receiving additional user information. The interface 800 comprises a first content well 801 and a second content well 802, each of which comprises visual fields similar to the visual fields in interface 700. The interface 800 is provided for receiving information regarding additional vehicles the user wishes to insure. In a preferred embodiment, the interface 800 is generated only based on the user's indication, in visual field 405, that the user wishes to insure more than one vehicle. A content well 801, 802 is then generated for each of the vehicles the user wishes to insure.

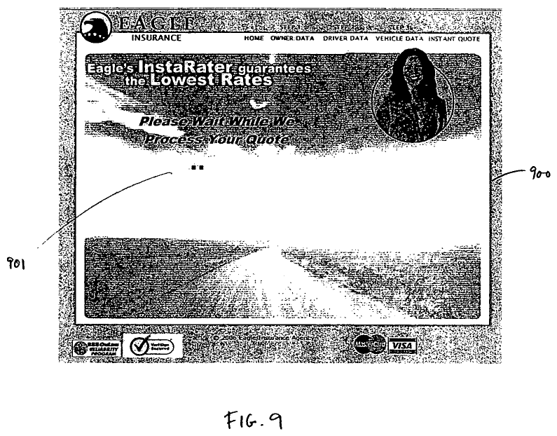

Referring now to FIG. 9, a interface 900 is provided for indicating to the user that the present invention is in the process of preparing an insurance offer to be presented to the user. In a preferred embodiment, the interface 900 comprises an indicator 901, which indicates the amount of time remaining before the process is complete and the user is presented with an insurance offer. The indicator 901 may also comprises a visual moving image, representing to the user that the system is in the process of generating an insurance offer for the user.

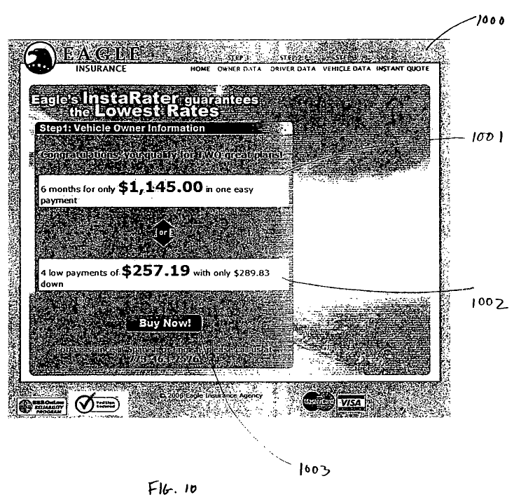

Referring now to FIG. 10, an offer interface 1000 is provided, comprising a plurality of insurance policy offers 1001, 1002. Each of the insurance policy offers 1001, 1002 comprises a purchase value. In a preferred embodiment, each of the insurance policy offers 1001, 1002 comprises a monthly payment amount, a lump sum payment amount and/or a duration for which the policy is effective. The offer interface 1000 also comprises an acceptance initiating function 1003, which initiates another interface (not shown) through which the user can purchase one of the insurance policy offers 1001, 1002.

The present invention provides a database 22 storing a plurality of insurance policy offers, each of which is correlated with a base purchase price. The base purchase price represents the cost of the premium (and/or monthly premium installments) the user will pay to purchase the insurance policy. The database 22 also preferably stores the user information, provided in the various interfaces as discussed herein. The present invention further provides a processor 16, for generating an adjusted purchase value for at least one of the plurality of insurance policy offers stored in the database 22. The adjusted purchase value is the base purchase value, which is then either increased or decreased by the processor 16 depending on the user information provided to the system. The generation of the adjusted purchase price is accomplished by the processor 16 by executing a query on the data stored in the database 22, as will be understood by one of skill in the art. For example, the database 22 may store information in a data field regarding whether the user has a suspended driver's license. The processor 16 executes a query on that field to determine whether the value in the field is positive or negative. If the result of the query is positive (i.e., the user has a suspended driver's license), the processor 16 then executes a second query, which accordingly increases the adjusted purchase value of at least one of the insurance policy offers stored in the database 22. That process of executing a query on data stored in a database, to achieve a resultant value, is commonly referred to as a “formula” or a “function”, and is known to one of skill in the art. Through that process, the processor 16 thus generates an adjusted purchase value based on the user information.

In a preferred embodiment, the generation of the adjusted purchase value does not comprise either information regarding the user's driving record, or information regarding the user's financial history. Specifically, in that preferred embodiment, the adjusted purchase value is not based on the number of “points” the user has on her driver's license, nor is it based on the specific driving record of the user. Likewise, in that preferred embodiment, the adjusted purchase value is not based on the user's credit history, credit rating or other considerations regarding the user's ability to pay the premiums corresponding to the insurance policy. Therefore, a core aspect of the present invention is that it is dramatically faster than the present invention, and can provide an auto insurance estimate via the user interface in less than two minutes, assuming an average user data entry speed. The present invention does not require information concerning the individual driver and does not require information concerning the vehicle owner. As a result, the system is more streamlined and faster than known systems in the prior art.

The present invention further provides a system for assigning the user to a demographic category, which is then stored in the database 22 and used by the processor 16 to generate an adjusted purchase value. The demographic category describes the user in general, such as a married woman in her forties who lives in a suburban community. That demographic category is then used by the processor 16 to generate the adjusted purchase value of at least one of the plurality of insurance policies.

In a preferred embodiment, a plurality of the interfaces of the present invention comprise a visual component comprising an image 302 depicting a human form, and an audio component (not shown) depicting a human voice. The image 302 is displayed as part of the interface through the use of an audiovisual Internet website, using web page programming techniques for displaying images on a website known to one of skill in the art. The audio component is also embedded within the website using website programming techniques known to one of skill in the art. The image 302 and the audio component are configured so as to indicate a correlation between the two. For example, as illustrated in FIG. 3, the image 302 can be an image of a woman. In that example, the audio component would be an audio segment of a woman's voice.

It will be understood that the image 302 and the audio component can be figured to look like, and sound like, whatever is desired by the managing user of the present system. However, in a preferred embodiment and as illustrated in FIG. 3, the image 302 is an image of a woman. The audio component played through the speakers of the computer 12 and embedded within the interface 300 is the voice of a woman reading the text: “I am Lisa. Welcome to the Eagle Insurance website. Eagle's INSTA RATER estimating system will quote you the lowest car insurance and SR22 rates available in less than 3 minutes. It's as simple as Click, Quote, Buy.”

The audio component embedded in the user interface 400 illustrated in FIG. 4 is the voice of a woman reading the text: “First, please give me the vehicle owner's information. If you make any mistakes, it's easy to fix. I will see you on page two when you are finished.” The audio component embedded in the user interface 500 illustrated in FIG. 5 is the voice of a woman reading the text: “On this page, please give me the driver's information. If you want to add or delete, you can do as many drivers as you need. I will see you on page three when you are finished.” The audio component embedded in the user interface 700 illustrated in FIG. 7 is the voice of a woman reading the text: “Finally, please give me information about all the vehicles you want to include. You can add or delete as many vehicles as you need.” The audio component embedded in the interface 1000 illustrated in FIG. 10 is the voice of a woman reading the text: “Congratulations, our INSTA-RATER estimating system found the lowest rate for you. Click the BUY button to complete this process online.” As illustrated in FIGS. 4, 5, 7 and 10, the image 302 can be the same image in each of the various interfaces of the present system. However, it will be understood that the image 302 can be altered so as to appear differently in each interface from another interface, without departing from the principles of the present invention.

The present invention provides an efficient user interface for providing the user information in three distinct segments: driver information interface 500, owner information interface 400 and vehicle information interface 700. In a preferred embodiment, the three types of user information are provided by the user in the three separate user interfaces, although it is contemplated that all of the information can also be provided in a single interface combining the visual fields that comprise the interfaces. The driver information preferably comprises exactly the following driver information elements: driver location 506 (the driver's zip code, city, state, county and region), driver date of birth 502, driver state of licensure 506, driver gender 503, driver marital status 504 (whether single, married or divorced), driver license status 507 (whether current, suspended, or revoked) and an indicator 508 as to whether the driver requires a SR-22 statement (an industry-standard statement indicating that the driver is not the owner of the vehicle, but has financial responsibility for the vehicle). The owner information preferably consists of exactly the following owner information elements: owner location 402 (the driver's zip code, city, state, county and region), owner prior insurance duration 406 (the length of time during which the owner has had continuous automobile insurance coverage), the number 404 of drivers driving the owner's vehicle and the number 405 of vehicles owned by the owner,

The vehicle information preferably consists of exactly the following vehicle information elements: vehicle identification number 704, vehicle year 701, vehicle model 703, primary vehicle purpose 706 (whether recreational, commercial, etc.) and coverage type 707 (whether comprehensive, collision, etc.). One novel feature of the present invention is that the driver information, owner information and vehicle information consist exactly of the elements described herein, do not include any additional elements, and do not exclude any of the elements described herein. By not requiring additional information, the present system is therefore capable of generating insurance policy quotes much more efficiently than known systems of its type.

Each of the driver information elements, owner information elements, and vehicle information elements is associated with a discreet range of adjustment values, which represents a dollar amount. For example, the driver's age is associated with a discreet adjustment range of +$1,000 to −$1,000. In the example, a very young driver (e.g., a driver of age 16) represents a greater insurance risk. The driver's age (e.g., 16) is therefore associated with an adjustment value at the upper end of the discreet range, for example, +$1,000. Conversely, a driver of experienced age (e.g., 35) is associated with an adjustment value at the low end (e.g., −$1,000) of the discreet range. It will be understood that the boundaries of the range of adjustment values are determinable by the manager of the present system, and can be altered as desired.

For each of the elements of the driver information, owner information and vehicle information, a selected adjustment value is selected. For example, a driver of age 16 corresponds to an adjustment value of +$1,000, but the vehicle year of 1996 corresponds to an adjustment value of −$500. Each of the information elements provided by the user corresponds to an adjustment range, and for each of the information elements, an adjustment value is selected from within that range.

Next, for each of the plurality of insurance policy offers stored in the database, an adjusted purchase price is generated by first considering the base purchase price of the insurance policy offer, and then incrementing the base purchase price by the values selected from each of the plurality of ranges of discreet adjustment values. In the example provided above, if the base purchase price is $2,000, the base purchase price will then be incremented by the +$1,000 value selected based on the driver's age, and then incremented by the −$500 value selected based on the vehicle year. The resulting adjusted purchase price for that insurance policy offer is therefore a net $2,500. A selected insurance policy offer is then selected from among the plurality of insurance policy offers. In a preferred embodiment, the selected insurance policy offer is the insurance policy offer having the smallest adjusted purchase price.

In a preferred embodiment, the three interfaces (driver information, owner information and vehicle information) comprise three distinct “steps” of the method for generating an insurance policy offer. In known systems of this type, users are required to advance through a multitude of interfaces for providing a variety of different types of information. The process usually takes at least fifteen minutes. But in the present system, only three “steps”—i.e., three interfaces—are required, a process that takes less than two minutes. For that additional reason, the system is therefore more efficient than other known systems of its type.

It is also contemplated that in each of the three interfaces 400, 500, 700, the user can select to advance to another of the three interfaces. For example, while viewing the driver information interface 500, the user can select to advance immediately to the vehicle information interface 700. Referring to FIG. 4, that feature is accomplished by providing three links 408, 409, 410 on the web interfaces 400, 500, 700 of the present invention, as will be understood by one of skill in the art, wherein each of the links 408, 409, 410 corresponds to one of the portions of the user interface 400, 500, 700. It is further contemplated that in the insurance policy offer interface 1000, in which the user is presented with the selected insurance policy offer at the adjusted purchase value, that the user will be able to use those links 408, 409, 410 to quickly change any element of the user information, and thereby generate a different selected insurance policy offer.

In one embodiment of the present invention, the interface screens can be configured to allow the user to be able to add, delete, and/or edit the necessary information to obtain an insurance estimate or quote from or on the same screen without going to any different or other screens for each such task or function. Specifically, the existing Vehicle Owner, Vehicle Driver and Vehicle data entry screens 400, 500, 700, and information entry fields and pull down menus within such already described interface screens, can be combined into one screen to allow a user to enter, delete, and/or edit such information needed to establish an estimate or quote.

In a further embodiment as described above, all of the information on a driver which will use a vehicle to be insured, necessary to establish an estimate or quote, can be added, deleted and/or or edited and obtained from the display and use of a single interface screen and respective input fields and drop down menus, as shown and described in and for FIG. 5 or 6. Furthermore, all of the information on a vehicle to be insured necessary to establish an estimate or quote can be added, deleted, and/or edited and obtained from the display and use of single interface screen and respective input fields and drop down menus, as shown and described in and for FIG. 7. These and the owners information screens provide a smooth transition between and among each other with the use of the noticeable links for the other interface screens in a conspicuous location on each interface screen, such as at the top of each interface screen.

In addition, when changing information on each interface screen, such as on the vehicle information screen, the system can be configured so that no page flickers occur (no white or other screens will appear when information is added, modified or deleted, such as when whole page refreshes to obtain the latest information to display on the screen). Specifically, the system and code therein can be configured and/or programmed so that individual input field or less than all of the input fields (or the entire screen), will refresh without the rest of the input fields or the entire screen refreshing. This assists in making the use of the interface screens by a user and potential purchaser of auto insurance more efficient, and prevent the system from causing the user to become disenfranchised with obtaining an estimate or quote for auto insurance. As an example, when a client (user) sends data to the server by performing any of the acceptable actions, such as clicking a button, clicking a link, selecting an item, changing the value in a text box, the server processes the posted data and sends a response back to the client and updates the information on the page at the client. The whole cycle is called post-back. Usually, whenever a post-back occurs, the whole web page refreshes to display the updated information to the client. However, in one aspect of the present invention, as a specific example, in FIG. 7, when a user selects “2005” as Year in the “Year” selection or input field/list, the data is sent to the server and the server responds back to the client by filling the corresponding list of “Makes” for 2005 in the selection field/list “Make” so that user can select proper Make. This whole process occurs as a post-back refresh. In one embodiment, post-back refreshes occur every time the user selects Year, Make, Model and VIN Number selection fields to update the page. Other fields can be updated or refreshed in this manner as well. For typical post-back refreshes, the whole web page refreshes (page flicker), and if the internet speed of the user is slow, the page stays as white page until it is refreshed. This is can be annoying to the user when he/she tries to update information on the page and make proper selections, and can disenfranchise the user with the process and company trying provide the estimate or quote. The system, thus, allows for partial refresh for updating of the screens, such as for post-back refreshes, which will allow for updating of information only on the section of the page where the changes need to be made, and provide a better user experience.

In one embodiment, after information is entered or updated within any or all of the Owner screen, Driver screen and/or Vehicle screen and the respective input fields therein, with a single click of the “Instant Quote” button/link by the user, the system will calculate, determine and/or obtain an estimate or quote for providing on the display of the client computer. The Instant Quote button or link, as shown in the Figures, can be provided on the various interface screens, to allow the user to select this button or link from any one of the interface screens.

In a further embodiment, a predetermined default value or set of default values can be provided, stored in the memory or retrieved, obtained from or used within a third party computer system, for any input field for any of the user interface screens, which is left blank by the user. The value of the default value will depend on the input field in question, and should be appropriate for such field. The system can be configured to allow an administrator of the system to change the default values or the default values can be hard coded into the software code. In either case, the default values can be set at the lowest values commercially possible and feasible, yet appropriate, for such input field and value, in order to obtain and the lowest insurance estimate or rate. For example, of no data was entered into model and make of a car, the make and model of the least expensive type of car to insure will be used within any determination of an estimate or quote for insurance.

In one embodiment, the system is configured to provide and/or includes software code segments to provide a single user interface for receiving, from a user, all driver information necessary for establishing and presenting an insurance offer. The single user interface or single screen has input fields for receiving at least a driver zip code, a prior insurance duration, a driver date of birth; and a driver state of licensure. In a further embodiment, the system is configured to provide and/or includes software code segments to provide a single user interface for receiving, from a user, all vehicle owner information necessary for establishing and presenting an insurance offer. The single user interface or single screen has input fields for receiving from at least an owner zip code, an owner prior insurance duration, an owner date of birth, and an owner state of licensure. In a further embodiment, the system is configured to provide and/or includes software code segments to provide a single user interface for receiving, from a user, all vehicle information necessary for establishing and presenting an insurance offer. The single user interface or single screen has input fields for receiving from at least a vehicle make, a vehicle model, and a vehicle year; and/or a vehicle identification number. Other single screen arrangements are possible and would be understood by one of ordinary skill in the art from the present specification.

While the specific embodiments have been illustrated and described, numerous modifications come to mind without significantly departing from the spirit of the invention, and the scope of protection is only limited by the scope of the accompanying Claims.

What is claimed is:

1. A method for presenting insurance offers, comprising the steps of:
receiving user information from a user via a user interface, wherein the user information consists of:
a vehicle identification number;
a driver zip code;
a prior insurance duration;
a driver date of birth; and,
a driver state of licensure;
storing the user information in a database;
receiving a plurality of insurance policy offers, wherein each of the insurance policy offers comprises a base purchase price;
generating, for each of the plurality of insurance policy offers, an adjusted purchase price, wherein the adjusted purchase price is based on the base purchase price and the user information;
selecting a selected insurance policy offer from among the plurality of insurance policy offers; and,
displaying the selected insurance policy offer to the user via the user interface.

2. The method of claim 1, wherein the user information does not comprise user driving record information or user financial history information.

3. The method of claim 1, wherein the user information further comprises at least one of: city, state, county, region, number of drivers, number of vehicles, gender, marital status, license status, ownership status, vehicle year, vehicle model, primary vehicle purpose and coverage type.

4. The method of claim 1, wherein the step of generating the adjusted purchase price comprises incrementing the base purchase price based on one of: zip code, city, state, county, region, number of drivers, number of vehicles, prior insurance duration, date of birth, gender, marital status, licensure state, license status, ownership status, vehicle year, vehicle model, primary vehicle purpose and coverage type.

5. The method of claim 1, wherein the user interface comprises a visual component comprising an image depicting a human form, and an audio component depicting a human voice.

6. The method of claim 1, wherein the step of displaying the selected insurance policy comprises displaying a plurality of purchase options for purchasing the selected insurance policy offer.

7. The method of claim 1, wherein the user interface comprises a plurality of fields, the method further comprising the step of:
automatically populating fields in the user interface based on the user information.

8. The method of claim 1, wherein each element of the user information corresponds to a discreet range of adjustment values, the method further comprising the step of:
automatically selecting a minimum adjustment value from the discreet range of adjustment values.

9. A system for presenting insurance offers, comprising:
a first user interface for receiving, from a user, driver information consisting of:
a driver zip code;
a prior insurance duration;
a driver date of birth; and,
a driver state of licensure;
a second user interface for receiving, from the user, owner information consisting of:
an owner zip code;
an owner prior insurance duration;
an owner date of birth; and,
an owner state of licensure;
a third user interface for receiving, from the user, vehicle information consisting of:
a vehicle identification number;
a database for storing the driver information, owner information, and vehicle information, and for storing a plurality of insurance policy offers, wherein each of the insurance policy offers comprises a base purchase price, and for storing a plurality of discreet ranges of adjustment values, each of the plurality corresponding to each of the elements of the driver information, owner information and vehicle information;
a processor for generating an adjusted purchase price for each of the plurality of insurance policy offers, wherein the adjusted purchase price is incremented and decremented by the processor according to a value selected from the each of the plurality of discreet ranges of adjustment values.

10. The system of claim 9, wherein at least two of the first, second and third interface screens are combined into one interface screen.

11. The system of claim 9, wherein the first, second and third interface screens are combined into one interface screen.

12. The system of claim 9, wherein the system if configured to provide a get estimate selector within each of the first user interface, the second user interface and the third user interface, for obtaining and displaying an insurance estimate or quote from each of the first, second and third interface screens.

13. The system of claim 9, wherein driver information, owner information and vehicle information does not comprise driving record information or user financial history information.

14. The system of claim 9, wherein the processor automatically selects a minimum adjustment value from each of the plurality of discreet ranges of adjustment values.

15. The system of claim 9, wherein at least one of the first, second and third user interfaces comprises a visual component comprising an image depicting a human form, and an audio component depicting a human voice.

16. The system of claim 9, further comprising:
a fourth user interface for displaying a selected insurance policy offer selected automatically by the processor, wherein the selected insurance policy offer has the lowest adjusted purchase price from the among the plurality of insurance policy offers, and wherein the fourth user interface comprises a plurality of purchase options.

17. The system of claim 9, wherein at least one of the first, second and third user interfaces comprises a plurality of fields, wherein the processor automatically populates at lease one of the plurality of fields based on the driver, owner and vehicle information.

18. The system of claim 9, wherein the selected insurance policy offer has the smallest adjusted purchase price from among the plurality of insurance policy offers.

19. The system of claim 9, wherein each of the user interface screens comprises information entry fields for each of the respective information, and wherein the system is configured to refresh less than all of the information entry fields upon entry, deletion or modification of the respective information into one or more of the information entry fields.

20. The system of claim 19, wherein the system is configured to only refresh the information entry field for which information is being entered, deleted or modified.

21. A method for presenting an insurance offer, comprising the steps of:
receiving a vehicle identification number from a user;
analyzing the vehicle identification number to determine a plurality of indicators;
receiving an insurance policy offer having a base purchase price;
selecting a selected indicator from among the plurality of indicators;
comparing the selected indicator to a threshold;
generating an adjusted purchase price that is greater than the base purchase price based on a determination that the selected indicator exceeds the threshold; and,
presenting the insurance policy offer to the user at the adjusted purchase price.

22. The method of claim 21, wherein the vehicle identification number is received via a user interface, wherein the user interface comprises a visual component comprising an image depicting a human form, and an audio component depicting a human voice.

23. The method of claim 21, wherein the step of presenting the insurance policy offer to the user comprises presenting a plurality of purchase options for purchasing the selected insurance policy offer.

24. The method of claim 22, wherein the user interface comprises a plurality of fields, the method further comprising the step of:
automatically populating one of the plurality of fields based on the vehicle information number.

25. A method for presenting an insurance policy offer, comprising the steps of:
receiving driver information consisting exactly of driver information elements: a driver zip code, a prior insurance duration, a driver date of birth, and a driver state of licensure;
receiving owner information consisting exactly of owner information elements: an owner zip code, a prior insurance direction, a driver date of birth, and a driver state of licensure;
receiving a vehicle identification number;
associating each of the driver information elements and each of the owner information elements with a discreet range of adjustment values, wherein the discreet range of adjustment values represents a dollar amount;
storing a plurality of insurance policy offers in a database, wherein each of the plurality of insurance offers has an associated base purchase price;
selecting for each of the driver information elements and each of the owner information elements, a selected adjustment value from the discreet range of adjustment values; and,
generating an adjusted purchase price for each of the plurality of insurance policy offers, wherein the adjusted purchase price is equal to the base purchase price added to the selected adjustment value;
selecting a selected insurance policy offer from among the plurality of insurance policy offers, wherein the selected insurance policy offer has the lowest adjusted purchase price; and,
presenting the selected insurance policy offer in a user interface comprising a plurality of data fields corresponding to the driver information elements, owner information elements and the vehicle identification number.

26. A system for presenting insurance offers, comprising:
a single user interface for receiving, from a user, all driver information necessary for establishing and presenting an insurance offer, comprising:
a driver zip code;
a prior insurance duration;
a driver date of birth; and,
a driver state of licensure.

27. The system of claim 26, wherein the single user interface is configured to receive all driver information for multiple drivers.

28. A system for presenting insurance offers, comprising:
a single user interface for receiving, from a user, all vehicle owner information necessary for establishing and presenting an insurance offer, comprising:
an owner zip code;
an owner prior insurance duration;
an owner date of birth, and, an owner state of licensure.

29. A system for presenting insurance offers, comprising:
a single user interface for receiving, from a user, all vehicle information necessary for establishing and presenting an insurance offer, comprising a vehicle make, a vehicle model, and a vehicle year; or a vehicle identification number (VIN).

30. The system of claim 29, wherein the single user interface is configured to receive all vehicle information for multiple vehicles.
